(19) United States
(12) Patent Application Publication
(10) Pub. No.: US 2015/0013667 A1
(43) Pub. Date: Jan. 15, 2015

(54) FOLDABLE BARBECUE GRILL

(71) Applicant: Rankam (China) Manufacturing Co. Ltd., Hong Kong (CN)

(72) Inventors: Ling Po Nancy HO, Hong Kong (CN); Jian LI, Hong Kong (CN)

(21) Appl. No.: 13/940,776

(22) Filed: Jul. 12, 2013

(51) Int. Cl. F24C 1/16; A47J 37/07

(52) U.S. Cl. CPC F24C 1/16; A47J 37/0763; A47J 2037/0777
USPC 126/9 B

(57) ABSTRACT

A foldable barbecue grill has a collapsible trolley and a stove removably disposable on the collapsible trolley. The trolley comprises a chassis and a pair of opposed side members foldable between collapsed and erected positions with respect to the chassis. Each side member has a pair of legs hingeably attached to respective corners of the chassis and a side bar extending between the legs. A respective pair of diagonal brackets is hingeably attached to the chassis and slideably cooperating with a respective one of the pair of legs as the side member moves between the collapsed and erected positions. Each diagonal bracket includes a clamp for locking the diagonal brackets with respect to the legs.

### BACKGROUND TO THE INVENTION

The present invention relates to a foldable barbecue grill, and in particular to a foldable barbecue grill having a trolley foldable between collapsed and erected positions and a stove removably disposable on the trolley.

Hitherto, some foldable barbecue grills have been disclosed. However, their folded form is irregular and can be slow or fiddly to erect. There is a need to have a foldable barbecue grill that is quick to erect, or at least provides the public with a useful choice.

### SUMMARY OF THE INVENTION

According to the invention there is provided a foldable barbecue grill comprising a trolley and a stove removably disposable on the trolley, the trolley comprising a chassis, a pair of opposed side members foldable between collapsed and erected positions, each side member comprising a pair of legs hingeably attached to respective corners of the chassis and a side bar extending between the legs, and a respective pair of diagonal brackets hingeably attached to the chassis and slideably cooperating with a respective of the legs as the side member moves between collapsed and erected positions, each diagonal bracket includes a clamp for locking the diagonal brackets with respect to the legs.

Preferably, the legs include a slot for receiving a pin of the diagonal bracket, the pin slideable within the slot.

Preferably, the clamp includes a fastener threadably engaged with the diagonal bracket and rotateable to project from the diagonal bracket such that it bears against the leg.

Preferably, the foldable barbecue grill further comprises a tray removably disposable between the side members in the erected position.

Preferably, the foldable barbecue grill further comprises a latch for releasably securing the stove with the trolley.

Preferably, the latch releasably secures the stove with the trolley when the trolley is in the collapsed position and when the trolley is in the erected position.

Further aspects of the invention will become apparent from the following description which is given by way of example only.

### BRIEF DESCRIPTION OF THE DRAWINGS

FIG. 1 is a perspective view of a foldable barbecue grill according to the present invention, in an operational condition,

FIG. 2 is a perspective view of the barbecue grill with trolley folded and in a stored condition,

FIG. 3 is a perspective view of the barbecue grill of FIG. 2, with the barbecue stove and folded trolley separated,

FIG. 4 is a perspective view of the barbecue grill trolley in an erected condition,

FIG. 5 is a perspective view of a bracket clamp of the barbecue grill trolley,

FIG. 6 is a perspective view of one end of the barbecue grill trolley, in an erected condition,

FIG. 7 is a perspective view of the of FIG. 1, with the barbecue stove and the erected trolley separated,

FIG. 8 is a perspective view of a latch of the barbecue stove, and

FIG. 9 is an exploded view the foldable grill.

### DETAILED DESCRIPTION OF PREFERRED EMBODIMENT

The following description is given by way of example only to illustrate the invention and is not intended to limit the scope of use or functionality of the invention. In particular, the invention is not limited in its application to the details of construction and the arrangements of components described in the following description or illustrated in the accompanying drawings. It will be evident to a skilled person that invention is capable of other embodiments and of being practiced or being carried out in various ways. Also, it is to be understood that the terminology used is for the purpose of description and should not be regarded as limiting.

In the drawings there is shown a foldable barbecue grill comprising a trolley 52 and a stove 51 removably disposable on the trolley 52. Other component parts are:

| | |
|---|---|
| 1 | Wind shield back panel |
| 2 | Cooking Grid |
| 3 | Wind Shield, right panel |
| 4 | Flame Tamer |
| 5 | Grill Body, back panel |
| 6 | Lead Fire Slot |
| 7 | Grill Body, right panel |
| 8 | Body Post |
| 9 | Side handle |
| 10 | Right side shelf |
| 11 | Regulator |
| 12 | Igniter rod |
| 13 | Baffle Board |
| 14 | Burner |
| 15 | Grill body front panel |
| 16 | Right Valve Install Plank |
| 17 | Right Valve Windpipe |
| 18 | Igniter Cover |
| 19 | Igniter |
| 20 | Control Panel |
| 21 | Grease receptacle |
| 22 | Grease tray |
| 23 | Gas Tank Hook |
| 24 | Right Side Member Leg |
| 25 | Gas Tank holder |
| 26 | Cart Chassis |
| 27 | Universal Caster |
| 28 | Directional Caster |
| 29 | Left Side Member Leg |
| 30 | Left Side Member Diagonal Brackets |
| 31 | Right Side Member Diagonal Bracket |
| 32 | Knob |
| 33 | Knob Holder |
| 34 | Left Valve Windpipe |
| 35 | Left Valve Install Plank |
| 36 | Left Side shelf |
| 37 | Igniter Wire 1 |
| 38 | Igniter Wire 2 |
| 39 | Left Side Plate, Body |
| 40 | Valve Install Plank Support |
| 41 | Windshield Left Panel |
| 42 | Gas collector box with Electrode |
| 43 | Body Strengthen Plank |
| 44 | Side Member |
| 45 | Upper Side Bar |
| 46 | Lower Upper Side Bar |
| 47 | Grease Receptacle Support |
| 48 | Leg Slot |
| 49 | Diagonal Bracket Clamp |
| 50 | Diagonal Bracket Pin |
| 51 | Stove |
| 52 | Trolley |
| 53 | Latch |

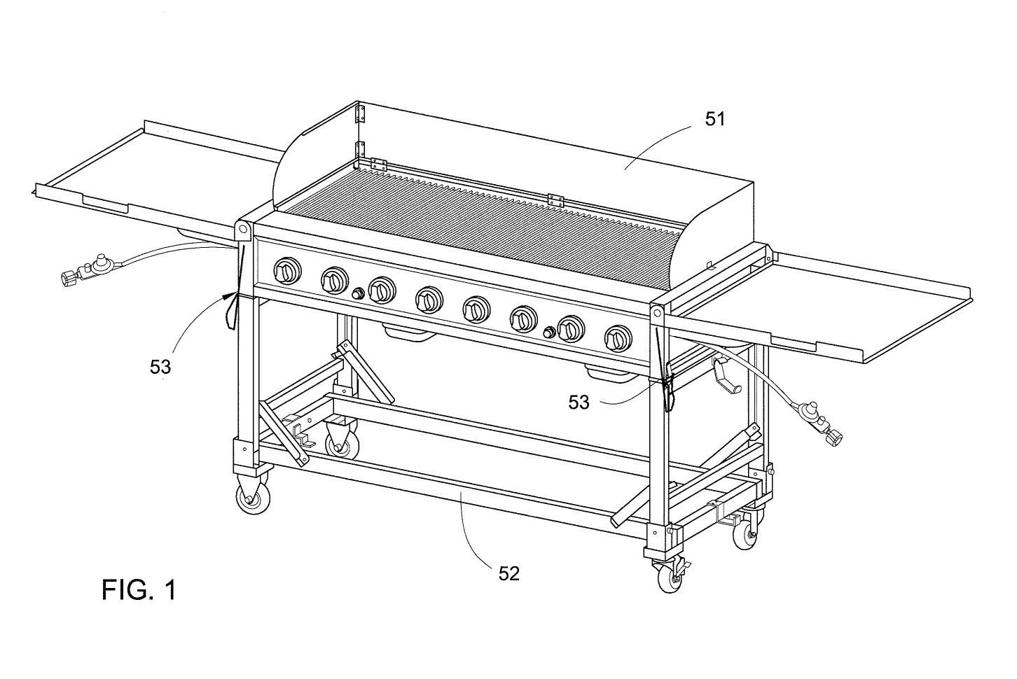

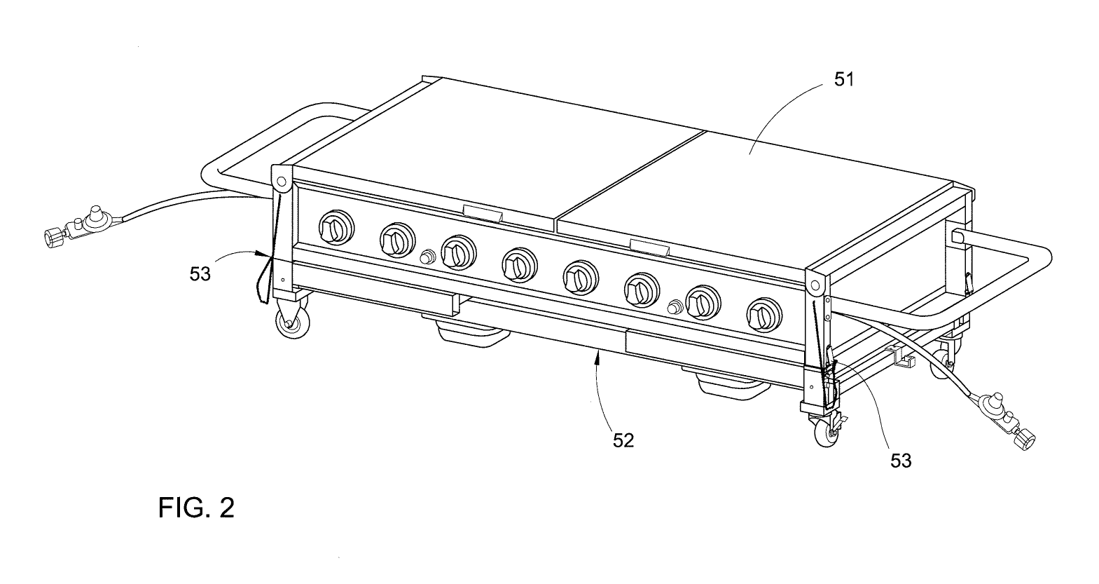

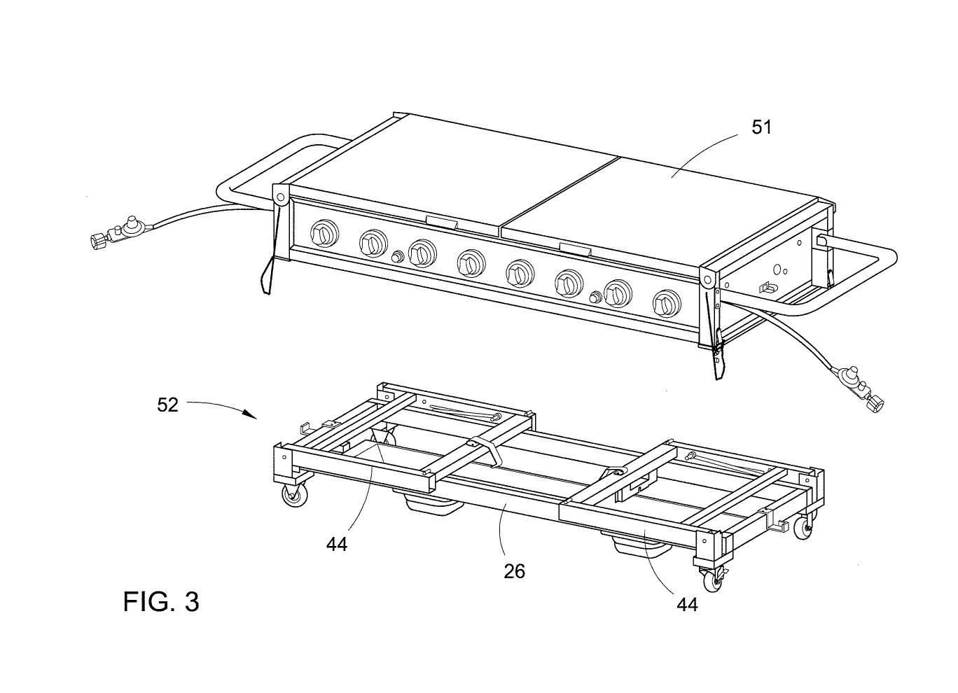

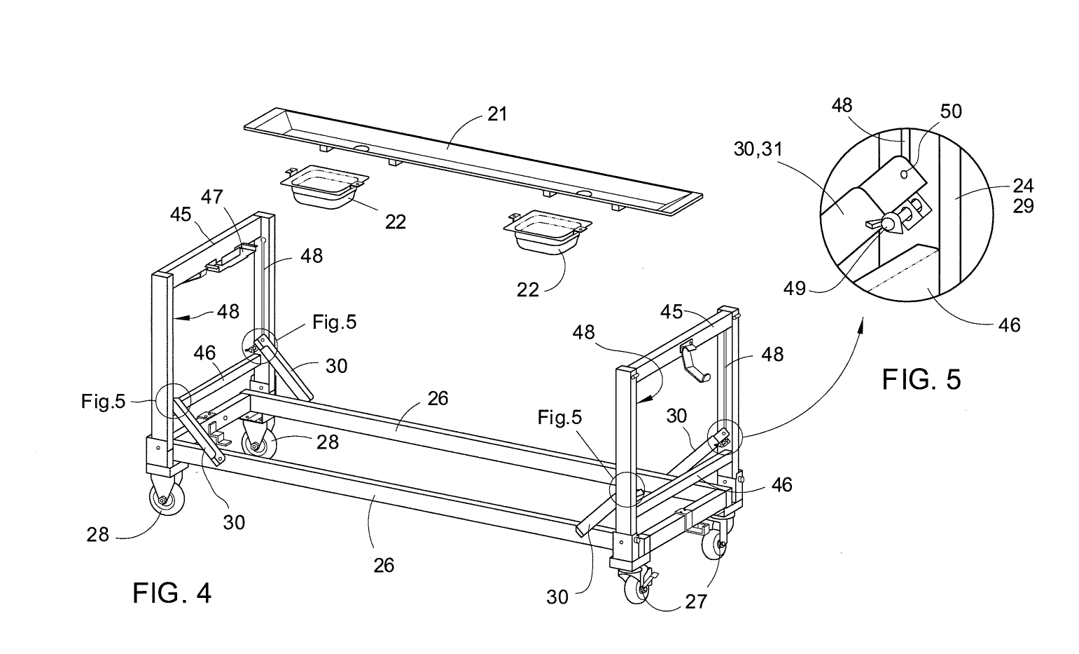

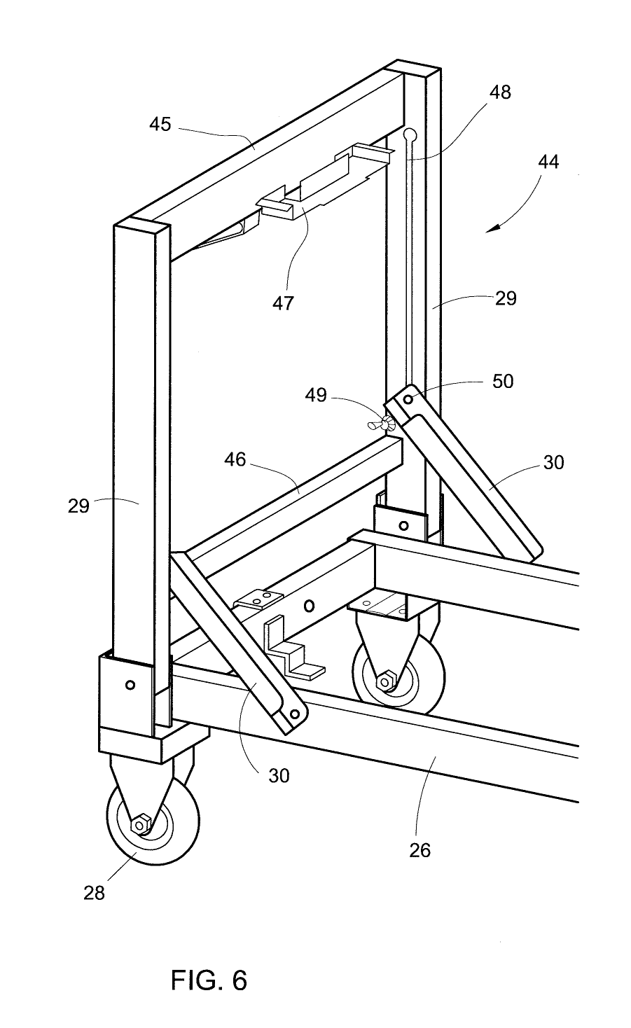

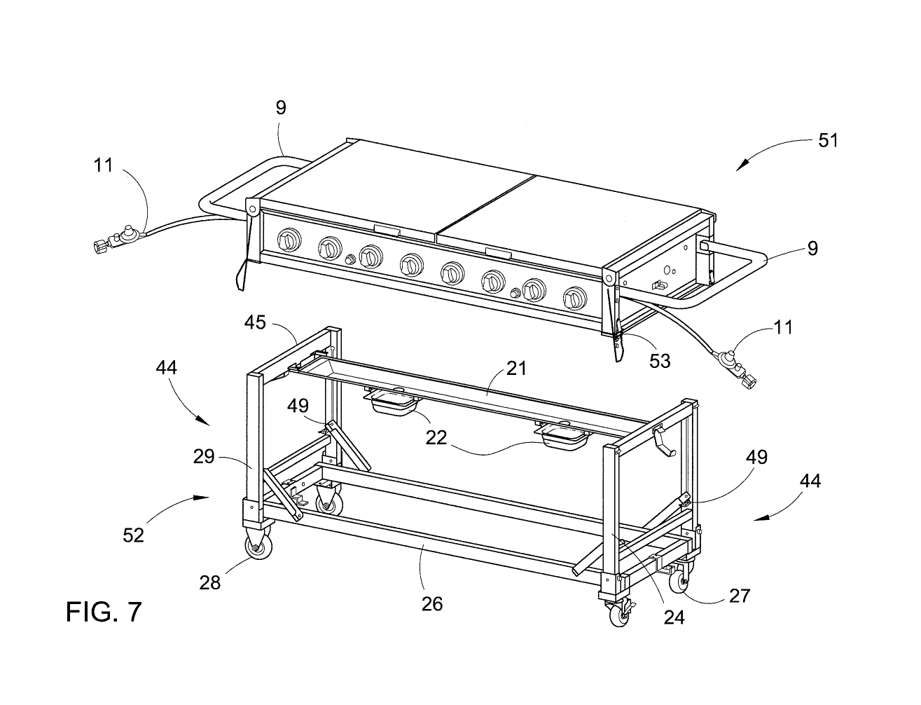

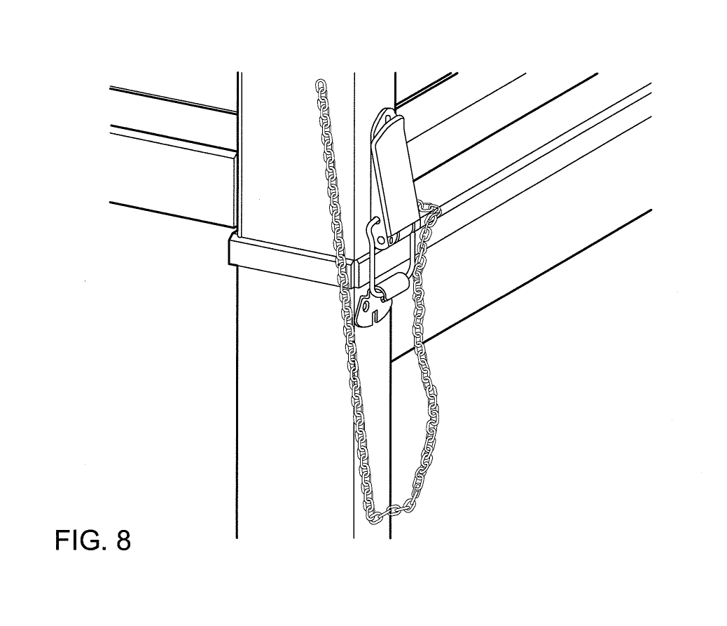

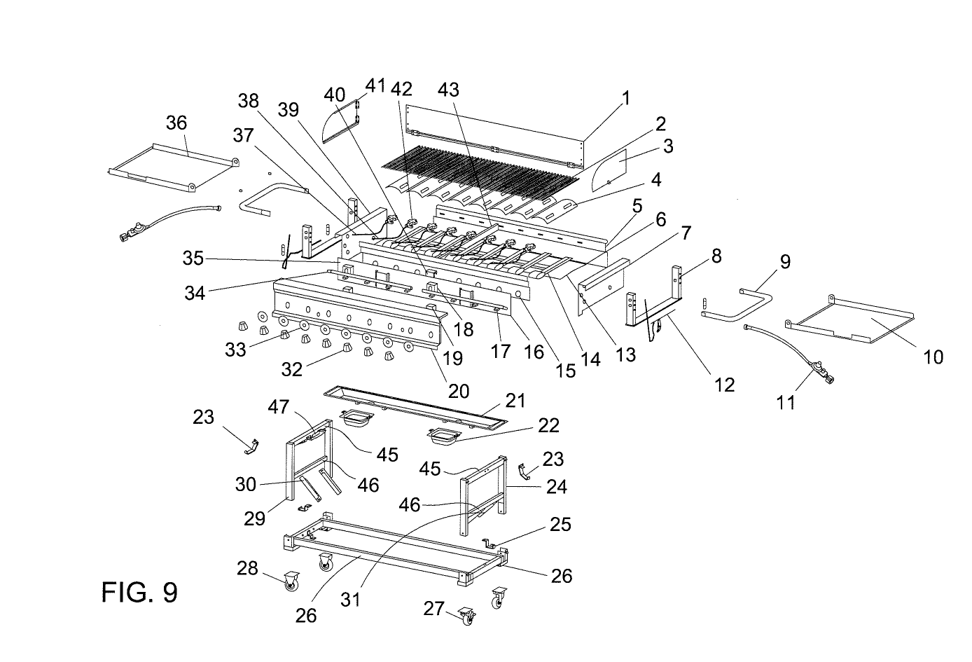

In the drawings there is shown a foldable barbecue grill comprising a trolley 52 and a stove 51 that is removably disposable on the trolley 52. The trolley 52 is foldable between a collapsed condition as shown in FIG. 2 and FIG. 3 and an erected condition as shown in FIG. 1 and FIG. 4 for example. The stove 51 is removably disposable on the trolley 52 when the trolley 52 is in either the collapsed and erected conditions. A first part of a latch 53 is provided in the side of the stove 51 and respective second latch receiving parts are located on the trolley for releasably securing the stove 51 with the trolley 52 when the trolley 52 is respectively in the collapsed condition and when the trolley 52 is in the erected condition. The foldable barbecue grill folds to the collapsed condition for storage and is quickly erects to the erected condition for use.

The foldable trolley 52 includes a chassis 26 and a pair of opposed hinged side members 44 hinged with the chassis 26 and foldable between the collapsed and erected condition. Each of the side members 44 consists of a pair of legs 24, 29 hingeably attached to respective corners of the chassis 26, a lower side bar 46 extending between respective ones of the legs 24, 29 intermediate the bottom and top of the side member 44 and an upper side bar 45 extending between respective ones of the legs 24, 29 at the top of the side member 44. A tray 21 is removably disposable between the top ends of the side members 44 of the trolley 52 when the side members 44 are in the erected position. The tray 52 may accommodate or support grease drip trays that in use reside below the stove member.

Each of the four legs (two legs per side member) has is a diagonal bracket 30, 31 that is hingeably attached to the chassis 26 and slideably cooperates with its respective one of the leg 24, 29. Each leg 24, 29 has an elongate slot 48 extending along its length from adjacent its lower hinged end to adjacent its top end. At the top end of each slot is an entry aperture. Each of the diagonal brackets 30, 31 has a pin 50 at its distal end which slidable engages with a respective elongate slot 48 so that the pin 50 slides within the slot 48 as the side member legs 24, 29 move between the collapsed and erected conditions.

Each of the diagonal bracket 30, 31 has a clamp at its distal end in association with the pin 50 for locking the pin 50 in the slot 48 and the diagonal brackets with respect to the legs 24, 29. The clamps are pre-assembled ‘Butterfly Head Screw” fasteners 49 that can easily help to fix the bracket to a position such that the leg 24, 29 is at right angles to support the grill automatically without using any tools. The threadably engaged ‘Butterfly Head’ fastener 49 are engaged with the diagonal brackets 30, 31 and are rotateable to project from the diagonal bracket 30, 31 such that they bears against the leg 24, 29.

Any reference to prior art contained herein is not to be taken as an admission that the information is common general knowledge, unless otherwise indicated.

1. A foldable barbecue grill comprising a trolley and a stove removably disposable on the trolley, the trolley comprising
a chassis
a pair of opposed side members foldable between collapsed and erected positions, each side member comprising a pair of legs hingeably attached to respective corners of the chassis and a side bar extending between the legs, and
a respective pair of diagonal brackets hingeably attached to the chassis and slideably cooperating with a respective of the legs as the side member moves between collapsed and erected positions, each diagonal bracket includes a clamp for locking the diagonal brackets with respect to the legs.

2. The foldable barbecue grill of claim 1 wherein the legs include a slot for receiving a pin of the diagonal bracket, the pin slideable within the slot.

3. The foldable barbecue grill of claim 1 wherein the clamp includes a fastener threadably engaged with the diagonal bracket and rotateable to project from the diagonal bracket such that it bears against the leg.

4. The foldable barbecue grill of claim 1 further comprising a tray removably disposable between the side members in the erected position.

5. The foldable barbecue grill of claim 1 further comprising a latch for releasably securing the stove with the trolley.

6. The foldable barbecue grill of claim 5 wherein the latch releasably secures the stove with the trolley when the trolley is in the collapsed position and when the trolley is in the erected position.

7. The foldable barbecue grill of claim 2 wherein the clamp includes a fastener threadably engaged with the diagonal bracket and rotateable to project from the diagonal bracket such that it bears against the leg.
